(19) United States
(12) Patent Application Publication
(10) Pub. No.: US 2024/0336748 A1
(43) Pub. Date: Oct. 10, 2024

(54) A METHOD FOR PREPARING HYALURONIC ACID GRAFTED POLY(N-ISOPROPYLACRYLAMIDE) (HA-G-PNI-PAM)

(71) Applicant: NABSOLUTE COMPANY LIMITED, Bangkok (TH)

(72) Inventors: Jittima Amie LUCKANAGUL, Bangkok (TH); Visarut BURANASUDJA, Bangkok (TH)

(21) Appl. No.: 18/579,153

(22) PCT Filed: Jul. 14, 2021
(86) PCT No.: PCT/TH2021/000040

§ 371 Date: Jan. 12, 2024

(51) Int. Cl. C08J 3/24; C08B 37/08; C08K 5/29

(52) U.S. Cl. CPC C08J 3/24; C08B 37/0072; C08K 5/29; C08J 2333/26

(57) ABSTRACT

This invention relates to a method for preparing hyaluronic acid grafted poly(N-isopropylacrylamide) (HA-g-pNIPAM) comprising the steps of: a) preparing a mixture comprising hyaluronic compound, poly(N-isopropylacrylamide) and carbodiimide crosslinking agent in a water-miscible solvent: b) reacting the mixture by adjusting pH to the range of 7.2 to 7.8 and stirring for 1 to 3 days at 20 to 40° C.; and c) drying the mixture of step b), wherein mole ratio of hyaluronic, poly(N-isopropylacrylamide), and carbodiimide crosslinking agent is in the range of 0.1:0.0025:1 to 0.2:0.0125:1.

### FIELD OF THE INVENTION

The present invention relates to the field of chemistry, in particular, a method for preparing hyaluronic acid grafted poly (N-isopropylacrylamide) (HA-g-pNIPAM).

### BACKGROUND OF THE INVENTION

Hyaluronic acid or HA is natural glycosaminoglycan (GAG) which is from the chemical bonding of D-glucuronic acid with N-acetyl-D-glucosamine to form disaccharide subunits. Such disaccharide subunits are linked via 2,4-glycosidic bond to form a long chain and large structure. Naturally, in 70 kilograms of human body, it is found that there are approximately 15 grams of HA within skin, joints, eyes and some other tissues. Nowadays, HA can be naturally produced from, for example, rooster's combs or the fermentation of Streptococcus aureus with the molecular weight of 5,000-1,800,000 kDa.

Hyaluronic acid has outstanding properties, especially water retainability, and it is found that 1 gram of HA can retain 6 liters of water. Moreover, HA has hygroscopic, appropriate viscosity to form gel, is biodegradable, and has biocompatibility properties. At present, HA is widely used for biomaterials and cosmetics, for example, gel, cream, foam, injections or hydrogel for anti-inflammatory, wound healing and tissue regeneration.

Poly(N-isopropylacrylamide) or pNIPAM is a thermo-responsive polymer which is from the polymerization reaction of N-isopropylacrylamide monomers. The lower critical solution temperature (LCST), or the temperature at which the polymer will undergo a phase transition from a flexible solvated to a more rigid unsolvated state, of pNIPAM is 32° C. pNIPAM has a reversible soluble-insoluble behavior due to LCST. When the temperature is less than 32° C., pNIPAM is hydrophilic and soluble. On the other hand, when the temperature is more than 32° C. (such as in body temperature), pNIPAM is hydrophobic, insoluble, and can form hydrogel which has tissue adhesion properties.

Nanogel is one type of colloid which is three-dimensional and nanosized hydrogel like materials in the nanoscale range. Major advantages of nanogel are water retainability, the ability to form emulsions which can be systemically delivered to organs, tissues, and cells that are difficult to reach, and the ability for rapid pharmacokinetics. Therefore, recent attention has been given to nanogel in the field of drug delivery, diagnostics, imaging, glucose sensing, and tissue engineering.

From literature reviews, the hyaluronic acid grafted poly(N-isopropylacrylamide) has been disclosed in the following documents:

Patent document US 20130171197 A1 disclosed hyaluronic acid grafted poly(N-isopropylacrylamide) hydrogel which has specific honeycomb structure. The said hydrogel can be formed with thermo-responsive property and can be used for increasing the efficiency of tissue engineering.

Chen et.al (Journal of pharmaceutical sciences, 2011, 100 (2), 655-666.) disclosed the hyaluronic acid grafted poly(N-isopropylacrylamide) hydrogel for drug delivery of cisplatin, cancer medicine. This said hydrogel has more than 40% of degree of grafting and form the network hydrogel.

Amenda (Wagner, A. 2019) disclosed hyaluronic acid grafted poly(N-isopropyl acrylamide) nanogel using 1-ethyl-3-(3-dimethylaminopropyl) carbodiimide (EDC), N-hydroxy succinimide (NHS) as carbodiimide crosslink agents. This said nanogel has about 25% of degree of grafting and further use for hydrophobic drug delivery system.

However, hyaluronic acid grafted poly(N-isopropylacrylamide) from previous disclosures has high viscosity and forms networking hydrogel due to high degree of grafting. Thus, the objective of this invention is to synthesize hyaluronic acid grafted poly(N-isopropylacrylamide) (HA-g-pNIPAM) with low degree of grafting that provides low viscosity, while maintaining high stability and biocompatibility. HA-g-pNIPAM in this invention can be used for many applications, such as delivery system, wound healing, cell proliferation, anti-inflammatory, antioxidant and photoprotection.

### SUMMARY OF INVENTION

In one embodiment, this invention relates to a method for preparing hyaluronic acid grafted poly(N-isopropylacrylamide) (HA-g-pNIPAM) comprising the steps of:
a) preparing a mixture comprising hyaluronic compound, poly(N-isopropylacrylamide) and carbodiimide crosslinking agent in a water-miscible solvent;
b) reacting the mixture by adjusting pH to the range of 7.2 to 7.8 and stirring for 1 to 3 days at 20 to 40° C.; and
c) drying the mixture of step b), 0.002:1:0.01 to 0.004:1:0.08
wherein mole ratio of hyaluronic, poly(N-isopropylacrylamide), and carbodiimide crosslinking agent is in the range of 0.1:0.0025:1 to 0.2:0.0125:1.

Further provided is hyaluronic acid grafted poly (N-isopropylacrylamide) (HA-g-pNIPAM) prepared by the above method.

### BRIEF DESCRIPTION OF THE DRAWINGS

FIG. 1 shows nuclear magnetic resonance (NMR) spectra of (a) Sample 1, (b) Sample 2, (c) Sample 3, (d) Sample 4, and (e) Sample 5.

FIG. 2 shows the chemical structure of hyaluronic acid grafted poly (N-isopropyl acrylamide) (HA-g-pNIPAM).

FIG. 3 shows infrared (IR) spectroscopic spectrum of Sample 2. The confirmation of grafting between HA and pNIPAM is shown as characteristic peaks at a wavenumber of 1606.4, 1406.3, and 1373.2 cm⁻¹.

FIG. 4 shows thermogravimetric analytical (TGA) spectrum of Sample 3.

FIG. 5 shows thermo-responsive property of Sample 3.

FIG. 6 shows transmission electron microscope (TEM) images of (a) 0.25% w/v of Sample 1, (b) 0.25% w/v of Sample 2, (c) 0.25% w/v of Sample 4, and (d) 0.25% w/v of Sample 5.

FIG. 7 shows cell proliferation efficiency of Sample 2 in (a) Keratinocyte (HaCaT cell) and (b) Fibroblast (BJ cell).

FIG. 8 shows wound healing efficiency of Sample 2 in (a) Keratinocyte (HaCaT cell) and (b) Fibroblast (BJ cell).

FIG. 9 shows anti-inflammatory efficiency of Sample 2 in Keratinocyte (HaCaT cell).

FIG. 10 shows anti-oxidation efficiency of Sample 2 in Keratinocyte (HaCaT cell), which (a) is with and without hydrogen peroxide (H₂O₂) and (b) is dose dependent effect.

FIG. 11 shows photoprotection efficiency of Sample 2 in Keratinocyte (HaCaT cell), which (a) is treated with UVA 5 J/cm³ and (b) is treated with UVA 7.5 J/cm³.

FIG. 12 shows collagenase degradation efficiency of Sample 2 in Keratinocyte (HaCaT)

FIG. 13 shows transmission electron microscope (TEM) images of curcumin encapsulated in (a) 0.25% w/v of Sample 1, (b) 0.25% w/v of Sample 4, and (c) 0.25% w/v of Sample 5.

FIG. 14 shows transmission electron microscope (TEM) images of asiatic acid encapsulated in (a) 0.1% w/v, (b) 0.15% w/v, and (c) 0.25% w/v of Sample 2.

FIG. 15 shows transmission electron microscopy (TEM) images of poly (I:C) encapsulated in (a) 0.1% w/v, (b) 0.25% w/v, and (c) 0.5% w/v of Sample 2.

FIG. 16 shows zeta potential and sizes of poly (I:C) encapsulated in (a) 0.1% w/v, (b) 0.25% w/v, and (c) 0.5% w/v of Sample 2.

FIG. 17 shows confocal microscopy images of curcumin cellular uptake efficiency test into NIH-3T3 cells of Sample 1, 4, and 5.

FIG. 18 shows confocal microscopy images of curcumin cellular uptake efficiency test into periodontal ligament stem cells of Sample 3.

FIG. 19 shows fibroblast growth factor (FGF) stability of Sample 2.

FIG. 20 shows curcumin solubility efficiency of (a) 0.1% w/v of Sample 2, and (b) 0.25% w/v of Sample 1, 4, and 5.

FIG. 21 shows asiatic acid solubility efficiency of Sample 2 (a) loading amount (mM), (b) loading efficiency (%), (c) loading capacity (%) and (e) entrapment efficiency (%)

FIG. 22 shows resveratrol solubility efficiency of Sample 2 in (a) without ethanol solution and (b) with ethanol solution.

FIG. 23 shows cytotoxicity in cornea epithelial cell at concentration of 0, 0.06, 0.12, 0.25, 0.5, 1 and 2% w/v of Sample 2.

FIG. 24 shows cell viability in Keratinocyte (HaCaT) at concentration of 0, 0.05, and 0.5% w/v in of Sample 2 irradiated with 7.5 J/cm² of ultraviolet-A (UVA).

FIG. 25 shows cell viability of at 0, 0.1, 0.15 and 0.25% w/v of Sample 2 via PrestoBlue™ assay.

### DETAILED DESCRIPTION OF THE INVENTION

The present invention relates to a method for preparing hyaluronic acid grafted poly(N-isopropylacrylamide) (HA-g-pNIPAM) with low degree of grafting which provides low viscosity, while maintaining high stability and biocompatibility. HA-g-pNIPAM in this invention can be used for many applications, such as delivery system, wound healing, cell proliferation, anti-inflammatory, antioxidant, and photoprotection.

Any aspects described here are meant to include the application to other aspects of this invention, unless stated otherwise.

### Definition

Technical terms or scientific terms used here have definitions as understood by person skilled in the art unless stated otherwise.

Any tools, equipment, methods, or chemicals named here mean tools, equipment, methods, or chemicals being used commonly by a person skilled in the art unless stated otherwise that they are tools, equipment, methods, or chemicals specific only to this invention.

Use of singular noun or singular pronoun with “comprising” in claims or specification means “one” and includes “one or more,” “at least one,” and “one or more than one” too.

All compositions and/or methods disclosed and claims in this application aim to cover embodiments from any action, performance, modification, or adjustment without any experiment that is significantly different from this invention and obtain with object with utility and resulted as same as the present embodiment according to person ordinary skilled in the art although without specifically stated in claims. Therefore, substitutable or similar objects to the present embodiment, including any minor modification or adjustment that can clearly be seen by a person skilled in the art should be construed as remaining in the spirit, scope, and concept of invention as appears in appended claims.

Throughout this application, the term “about” means any number that appears or shows here that could be varied or deviated from any error of equipment, method, or personal using said equipment or method.

Hereafter, invention embodiments are shown without any purpose to limit any scope of the invention.

In an exemplary embodiment, this invention relates to a method for preparing hyaluronic acid grafted poly(N-isopropylacrylamide) (HA-g-pNIPAM) comprising the steps of:
a) preparing a mixture comprising hyaluronic compound, poly(N-isopropylacrylamide) and carbodiimide crosslinking agent in a water-miscible solvent;
b) reacting the mixture by adjusting pH to the range of 7.2 to 7.8 and stirring for 1 to 3 days at 20 to 40° C.; and
c) drying the mixture of step b),
wherein mole ratio of hyaluronic, poly(N-isopropylacrylamide), and carbodiimide crosslinking agent is in the range of 0.1:0.0025:1 to 0.2:0.0125:1.

In a preferred exemplary embodiment, the carbodiimide crosslinking agent is selected from 1-ethyl-3-(3-dimethylaminopropyl) carbodiimide (EDC), N-hydroxy succinimide (NHS), N,N′-dicyclohexylcarbodiimide (DCC), N,N′-diisopropylcarbodiimide (DIC) or the mixture thereof.

In a preferred exemplary embodiment, the carbodiimide crosslinking agent is a mixture of 1-ethyl-3-(3-dimethylaminopropyl) carbodiimide (EDC) and N-hydroxy succinimide (NHS) in a mole ratio of 1:0.5 to 1:1.5

In a preferred exemplary embodiment, a weight average molecular weight of hyaluronic compound is in the range of 30,000 to 60,000 Dalton.

In a preferred exemplary embodiment, the hyaluronic compound is selected from hyaluronic acid, hyaluronate salt, or a mixture thereof.

In a preferred exemplary embodiment, the hyaluronate salt is selected from sodium hyaluronate, potassium hyaluronate, or a mixture thereof.

In a preferred exemplary embodiment, the hyaluronate salt is sodium hyaluronate.

In a preferred exemplary embodiment, a weight average molecular weight of poly(N-isopropylacrylamide) is in the range of 4,000 to 6,000 Dalton.

In a preferred exemplary embodiment, the water-miscible solvent used in step a) is selected from water, phosphate buffer saline (PBS), citrate buffer, Tris buffer, potassium phosphate buffer, hydroalcoholic solution or a mixture thereof.

In a preferred exemplary embodiment, the water-miscible solvent used in step a) is water.

In a preferred exemplary embodiment, the method further comprises a step of adjusting pH of the mixture obtained from step a) to the range of 4.8 to 5.8 and stirring the mixture for 0.5 to 2 hours prior to conducting step b).

In a preferred exemplary embodiment, the pH is adjusted by a pH adjuster selected from sodium hydroxide, potassium hydroxide, sodium bicarbonate, or calcium hydroxide or a mixture thereof.

In a preferred exemplary embodiment, the pH is adjusted by a pH adjuster selected from hydrochloric acid, or sulfuric acid or a mixture thereof.

In a preferred exemplary embodiment, the step c) is conducted by a process selected from freeze-drying, vacuum drying, or air drying or a combination thereof.

In a preferred exemplary embodiment, the method further comprises a step of purifying the product obtained from step b) prior to conducting step c).

In a preferred exemplary embodiment, the step of purifying is conducted by dialysis, cross flow filtration, liquid-liquid extraction or a combination thereof prior to conducting step c).

In another embodiment, this invention relates to a hyaluronic acid grafted poly(N-isopropylacrylamide) (HA-g-pNIPAM) according to the present invention.

In a preferred exemplary embodiment, the said hyaluronic acid grafted poly(N-isopropylacrylamide) (HA-g-pNIPAM) has a degree of grafting in the range of 4 to 8%.

In another embodiment, colloid of the hyaluronic acid grafted poly(N-isopropylacrylamide) according to the present invention in a water-miscible solvent selected from water, phosphate buffer saline (PBS), citrate buffer or a mixture thereof is at a concentration of 0.0001 to 2% w/v.

For a better understanding of the invention, examples of the hyaluronic acid grafted poly(N-isopropylacrylamide) according to the present invention will be shown, in which the following examples are for demonstrating the embodiment of this invention only, not for limitation of the scope of this invention.

It is noted that throughout this application, the water-miscible solvent can be selected from, but not limited to, deionized water, distilled water, tab water, phosphate-buffered saline (PBS), citrate buffer, cell culture media, Dulbecco's Modified Eagle Medium (DMEM), Minimum Essential (MEM), Medium HEPES (4-(2-hydroxyethyl)-1-piperazineethanesulfonic acid) buffer, Tris buffer, potassium phosphate buffer, hydroalcoholic solution, or biocompatible organic solvent, or mixture thereof. The biocompatible organic solvent is selected from a group of diluted methanol, diluted ethanol, or diluted acetic acid or mixture thereof.

### Preparation of Hyaluronic Acid Grafted Poly(N-isopropylacrylamide) (HA-g-pNIPAM)

### Samples 1 to 5

Samples 1 to 5 of hyaluronic acid grafted poly(N-isopropylacrylamide) (HA-g-pNIPAM) were prepared by following procedures:
(1) Sodium hyaluronate (NaHA) having weight average molecular weight at about 47,000 Dalton was dissolved in water;
(2) Poly(N-isopropylacrylamide) (pNIPAM) having weight average molecular weight at about 5,500 Dalton was added into the sodium hyaluronate solution from step (1), and then, 1-ethyl-3-(3-dimethylaminopropyl) carbodiimide (EDC) and N-hydroxysuccinimide (NHS) were subsequently added into the solution respectively;
(3) The pH of the solution from step (2) was adjusted to about 5.5 using sodium hydroxide and the reaction was kept for about 1 hour with stirring at room temperature;
(4) The pH of the solution from step (3) was once adjusted to about 7.5 using hydrochloric acid and the reaction was also kept at room temperature for about 3 days with stirring; and
(5) The HA-g-pNIPAM obtained from step (4) was purified by dialysis and dried by freeze-drying technique respectively;

Amounts of sodium hyaluronate (NaHA), poly(N-isopropylacrylamide) (pNIPAM), 1-ethyl-3-(3-dimethylaminopropyl) carbodiimide (EDC), and N-hydroxysuccinimide (NHS) used for Samples 1 to 5 are shown in Table 1.

Table 1 shows compositions of Sample 1 to 5

| | Sample | Sample | Sample | Sample | Sample |
|---|---|---|---|---|---|
| Composition | 1 | 2 | 3 | 4 | 5 |
| NaHA (mmol) | 1.26 | 1.26 | 1.26 | 1.26 | 1.26 |
| EDC (mmol) | 5.03 | 5.03 | 5.03 | 5.03 | 5.03 |
| NHS (mmol) | 5.03 | 5.03 | 5.03 | 5.03 | 5.03 |
| pNIPAM (mol) | 5.03 × | 5.66 × | 6.29 × | 7.55 × | 10.07 × |
| | 10⁻⁵ | 10⁻⁵10⁻⁵ | 10⁻⁵10⁻⁵ | 10⁻⁵10⁻⁵ | 10⁻⁵10⁻⁵ |

### Characterization of HA-g-pNIPAM of This Invention

### (1) Nuclear Magnetic Resonance (NMR)

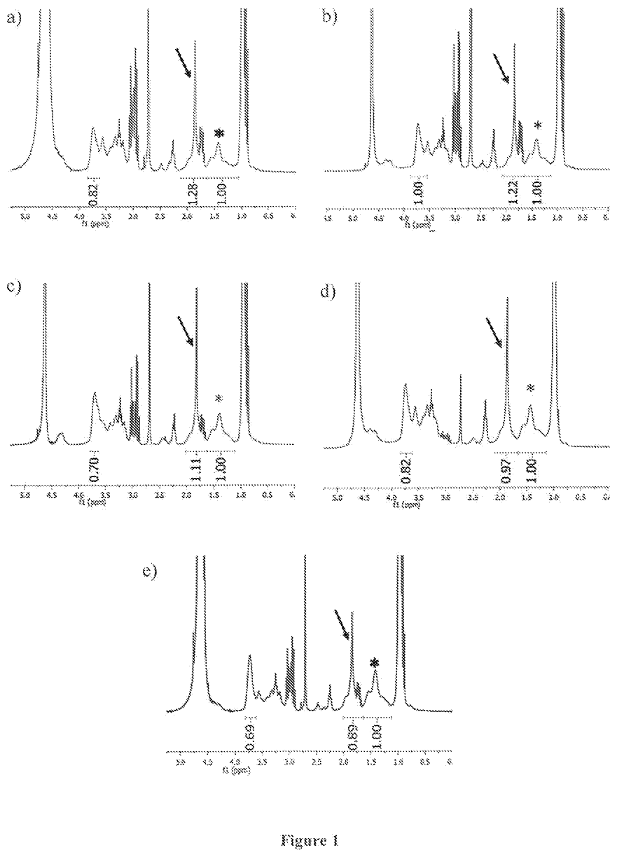

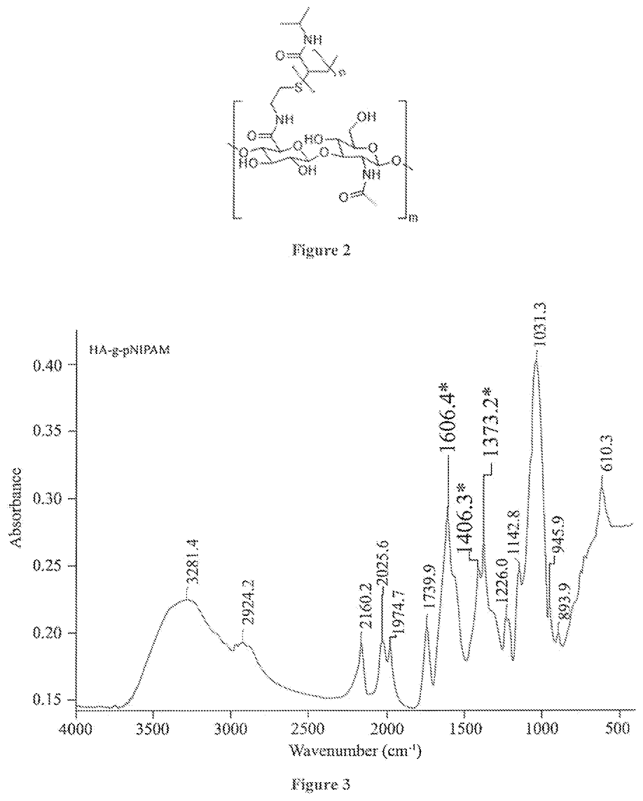

Nuclear magnetic resonance (NMR) spectra of Samples 1 to 5 are shown in FIG. 1. The results showed the Samples 1 to 5 had specific characteristic peaks of hyaluronic acid and poly(N-isopropylacrylamide), at which 1.10 to 1.65 ppm identified the aliphatic protons of poly(N-isopropylacrylamide) and 1.65 to 2.01 ppm identified the overlap of protons from N-acetyl group on D-glucosamine ring from hyaluronic acid and protons from poly(N-isopropylacrylamide). Moreover, the degree of grafting of Samples 1 to 5 was calculated by two marked peaks in NMR spectra. The chemical structure of hyaluronic acid grafted poly(N-isopropylacrylamide) (HA-g-pNIPAM) is shown in FIG. 2. Degree of grafting, average molecular weight, and weight ratio of pNIPAM and HA are shown in Table 2.

Table 2 shows the properties of hyaluronic acid grafted poly(N-isopropylacrylamide) (HA-g-pNIPAM) Samples 1 to 5

| | Sample | Sample | Sample | Sample | Sample |
|---|---|---|---|---|---|
| | 1 | 2 | 3 | 4 | 5 |
| Degree of | 4.0 | 4.5 | 5.0 | 6.0 | 8.0 |
| grafting (%) | | | | | |
| Average | 72,937.23 | 76,179.39 | 79,421.54 | 85,905.85 | 98,874.47 |
| molecular | | | | | |
| weight (Da) | | | | | |
| % Weight | 35.68 | 38.43 | 40.96 | 45.44 | 52.64 |
| of pNIPAM | | | | | |
| % Weight | 64.32 | 61.57 | 59.04 | 54.56 | 47.36 |
| of HA | | | | | |

### (2) Infrared Spectroscopy (IR) Spectra

Infrared (IR) spectrum of Sample 2 as shown in FIG. 3 showed characteristic peaks of HA-g-pNIPAM. The peak at 1,606 cm⁻¹ was ascribed to the amide band (stretching vibration of C═O). The peaks at 1,406.3 and 1,373 cm⁻¹ were the characteristic deformation vibration peaks of C—H bonds in the methyl groups of N-isopropylacrylamide. The IR results confirmed the existence of the HA grafted on pNIPAM core structure.

### (3) Thermogravimetric Analysis (TGA)

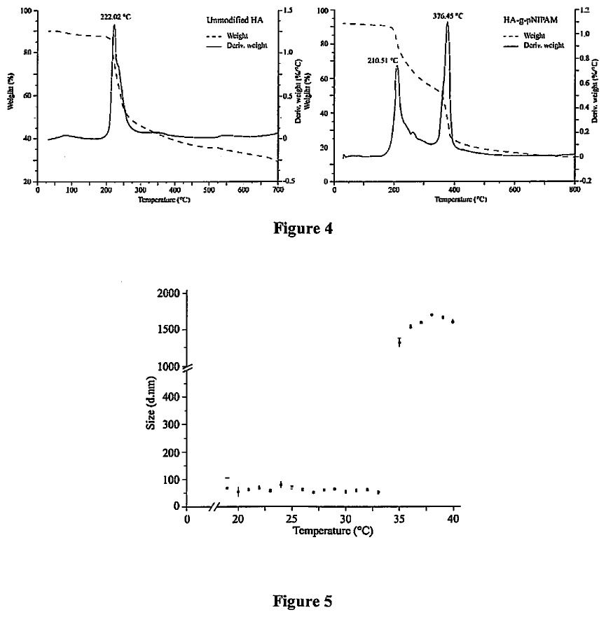

The thermal decomposition of Sample 3 was investigated by thermogravimetric analysis (TGA), the results of which are shown in FIG. 4. The results showed two parts of degradation of this Sample 3 at about 200 and about 400° C. Compared with a decomposition temperature of hyaluronic compounds, the degradation of Sample 2 occurred at about 200° C.

### (4) Particle Size

Sample 2 was dispersed in water to obtain colloid in the concentration range of 0.0001, 0.001, 0.01, 0.1 0.15 and 0.25% w/v. The obtained colloid of Sample 2 was investigated by dynamic light scattering (DLS). Particle size and average particle size of each concentration of Sample 2 in colloid form are shown in Table 3. The results showed the average particle size was increased when increasing the concentration of colloid.

Table 3 shows the particle sizes of Sample 2 in a form of colloid at different concentrations.

| | | Average |
|---|---|---|
| | Particle | particle |
| Concentration | size (nm) | size (nm) |
| 0.0001% w/v (25° C.) | 11-444 | 135.5 ± 81.6 |
| 0.001% w/v (25° C.) | 116-298 | 127.6 ± 47.8 |
| 0.01% w/v (25° C.) | 124-456 | 258.9 ± 20.8 |
| 0.1% w/v (25° C.) | 192-710 | 449.3 ± 4.3 |
| 0.15% w/v (25° C.) | 218-710 | 458.7 ± 8.2 |
| 0.25% w/v (25° C.) | 153-811 | 585.5 ± 6.7 |

### (5) Thermo-Responsive Property

The thermo-responsive property of Sample 3 colloid was studied by dynamic light scattering (DLS) technique.

The thermo-responsive property of Sample 3 is shown in FIG. 5. The results showed the spherical particles of 0.5% w/v of Sample 3 colloid having particle size in the range of about 30 to 80 nm at the temperature of about 25 to 32° C., and the particle size was increased when the temperature was more than 32° C. because of the lower critical solution temperature (LCST) property of poly(N-isopropylacrylamide).

### (6) Particle Morphology

Samples 1, 2, 4 and 5 were dispersed in water to obtain colloid in the concentration of 0.25% w/v. The obtained colloid was investigated by transmission electron microscope (TEM).

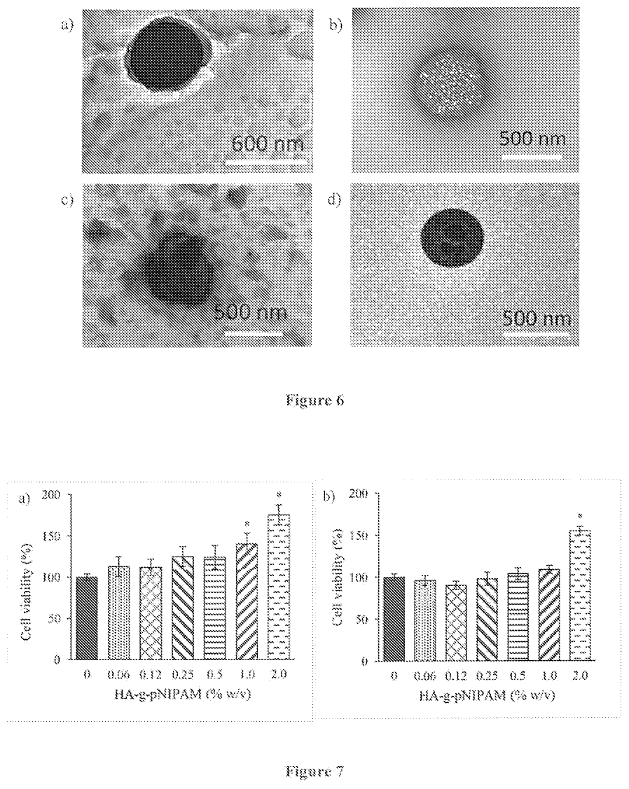

The morphology of the particles is shown in FIG. 6. The results showed that the colloid has well-defined spherical shapes as described in 0.25% w/v of Sample 1 (FIG. 6a), 0.25% w/v of Sample 2 (FIG. 6b), 0.25% w/v of Sample 4 (FIGS. 6c), and 0.25% w/v of Sample 5 (FIG. 6d).

### Efficiency Study of HA-g-pNIPAM

Hereinafter, the efficiency of HA-g-pNIPAM was studied by using Sample 1, 2, 4 and 5, in colloid form having a concentration in the range of 0.0001-2% w/v.

### (1) Cell Proliferation

Cell proliferation test of Sample 2 in colloid form was studied by using 3-(4,5-dimethylthiazol-2-yl)-2,5-diphenyl tetrazolium bromide (MTT) assay. MTT assay is a gold standard method to measure the viability and proliferation of cells. The experiment was performed following procedures: HaCaT keratinocytes and BJ fibroblasts were treated with Sample 2 at concentrations of 0, 0.06, 0.12, 0.25, 0.5, 1 and 2% w/v for 24 hours. After the treatments, cell proliferation was evaluated with MTT assay.

The cell proliferation efficiency test is shown in FIG. 7. The result showed that Sample 2 could promote the proliferation of skin cells as determined by an increase in cell viability of HaCaT keratinocytes (FIG. 7a) and BJ fibroblasts (FIG. 7b), compared with non-treated cells.

### (2) Wound Healing

Wound healing test of Sample 2 in colloid form was studied by the following procedures: BJ fibroblasts were scratched with razor blade, then cells were treated with Sample 2 at concentrations of 0.0001, 0.0005, 0.001, 0.005, 0.01, and 0.05% w/v for 24 hours. The healing activity of compound was observed by microscope.

The wound healing efficiency test is shown in FIG. 8. The result showed that Sample 2-treated fibroblasts could heal the wound faster than hyaluronic-acid-treatment and non-treated cells (FIG. 8a). The wound-healing activity of Sample 2 is in a dose-dependent manner (FIG. 8b). These results suggested that Sample 2 possessed promising wound healing activity.

### (3) Anti-Inflammatory

Anti-inflammatory test of Sample 2 in colloid form at concentration of 0.1% w/v was studied by the following procedures: HaCaT keratinocytes were treated with Sample 2 in a presence of tumor-necrosis-factor alpha (TNF-α) and interferon-gamma (IFN-γ) for 24 hours. After treatment, the levels of released TARC were measured with enzyme-linked immunosorbent assay (ELISA). TNF-α and IFN-γ are inflammatory inducers, while thymus and activation-regulated chemokine (TARC) are inflammatory markers.

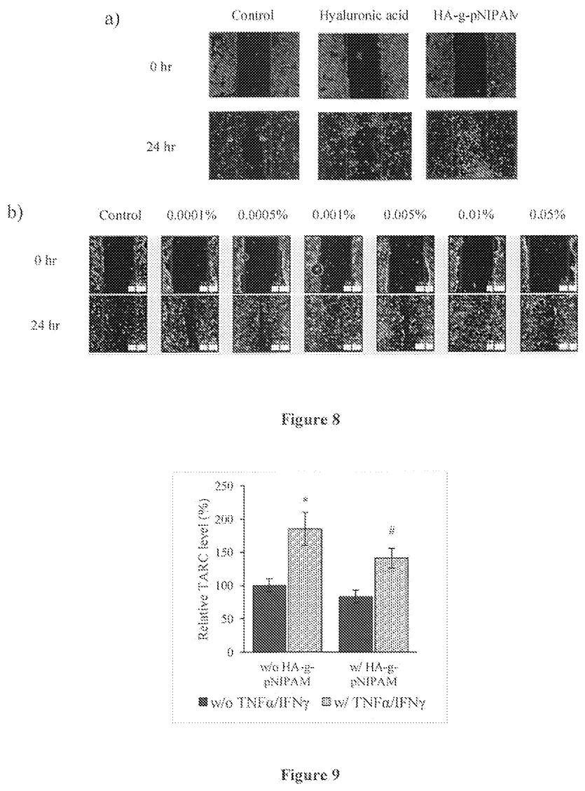

The anti-inflammatory efficiency test is shown in FIG. 9. The result showed that exposure to Sample 2 could reduce thymus and activation-regulated chemokine (TARC) levels, suggesting that Sample 2 had anti-inflammatory activity.

### (4) Anti-Oxidation

Anti-oxidation test of Sample 2 in colloid form was studied by the following procedures: HaCaT keratinocytes were treated with Sample 2 at concentrations of 0, 0.0005, 0.0001, 0.005, 0.01, 0.05 and 0.1% w/v for 24 hours. After treatment, cells were incubated with hydrogen peroxide for an hour, then the oxidative stress status were evaluated with 2′-7′-dichlorofluorescin diacetate (DCFH-DA) assay. Hydrogen peroxide was used as an oxidative stress inducer.

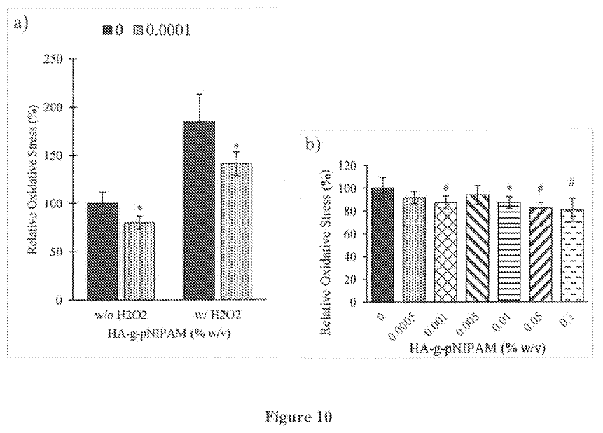

The anti-oxidation efficiency test is shown in FIG. 10. The result showed that Sample 2 could reduce oxidative stress following hydrogen peroxide treatment, indicating that Sample 2 had an anti-oxidation activity.

### (5) Photo-Protection

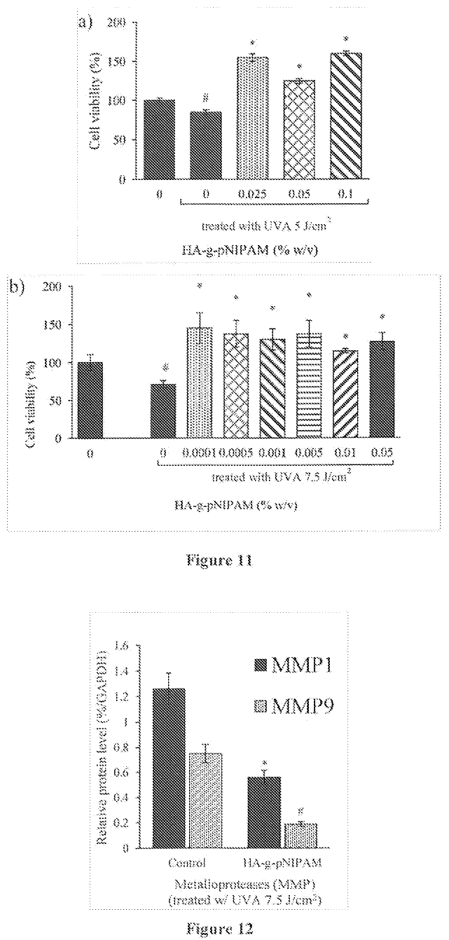

Photo-protection test of Sample 2 in colloid form was studied by the following procedures: HaCaT keratinocytes were treated with Sample 2 at concentrations of 0, 0.0001, 0.0005, 0.001, 0.01 and 0.05% w/v for 24 hours. After the treatment, cells were irradiated with 5 J/cm² (FIGS. 11a) and 7.5 J/cm² (FIG. 11b) of ultraviolet-A (UVA) and cell viability was then measured by MTT assay.

The photo-protection efficiency test is shown in FIG. 11. The result showed that Sample 2 could prevent keratinocytes from the toxicity of UVA irradiation, suggesting that Sample 2 had photo-protection activity.

### (6) Collagenase Degradation

Collagenase degradation test of Sample 2 in colloid form was studied by the following procedures: HaCaT cells were treated with Sample 2 for 24 hours. After the treatment, cells were irradiated with 7.5 J/cm² of ultraviolet-A (UVA). Levels of matrix metalloproteinase-1 (MMP-1) and matrix metalloproteinase-9 (MMP-9) were measured 24-hours after irradiation with western blot analysis.

The collagenase degradation efficiency test is shown in FIG. 12. The result showed that Sample 2 could inhibit expression of MMP-1 and MMP-9 in response to UVA irradiation. This result suggested that Sample 2 could enhance the degradation of collagenase.

### (7) Delivery System

Encapsulation of compounds including curcumin, asiatic acid and polyinosinic: polycytidylic acid (poly(I:C)) was studied by the following procedures: the compounds were encapsulated into the nanoparticles using a simple incubation method.

For curcumin, ethanolic stock solution of the curcumin was added dropwise into the Sample 1, 4 and 5 in colloid form the volume ratio of about 1:10 and incubated at 4° C. for 24 hours with constant stirring followed by centrifugation to remove undissolved compounds.

For asiatic acid, ethanolic stock solution of the asiatic acid was added dropwise into the Sample 2 in colloid form at the volume ratio of about 1:10 and incubated at 25° C. for 6 hours with constant stirring followed by centrifugation to remove undissolved compound.

For polyinosinic:polycytidylic acid (poly (I:C)), aqueous stock solution of poly (I:C) was added dropwise into the Sample 2 in colloid form at the volume ratio of about 1:10 at room temperature for 30 minutes under constant stirring. The morphological shape and appearance of the compounds encapsulated nanoparticles were observed by using transmission electron microscope (TEM) and measurements of size and zeta potential of polyinosinic: polycytidylic acid (poly(I:C)) encapsulated nanoparticles were performed using dynamic light scattering (DLS).

Transmission electron microscopy (TEM) images of the curcumin encapsulated nanoparticles are shown in FIG. 13. The results showed that the curcumin was successfully encapsulated into 0.25% w/v of Sample 1, Sample 4 and Sample 5 in colloid form as determined by the changes in the size, shape, and appearance of the nanoparticles.

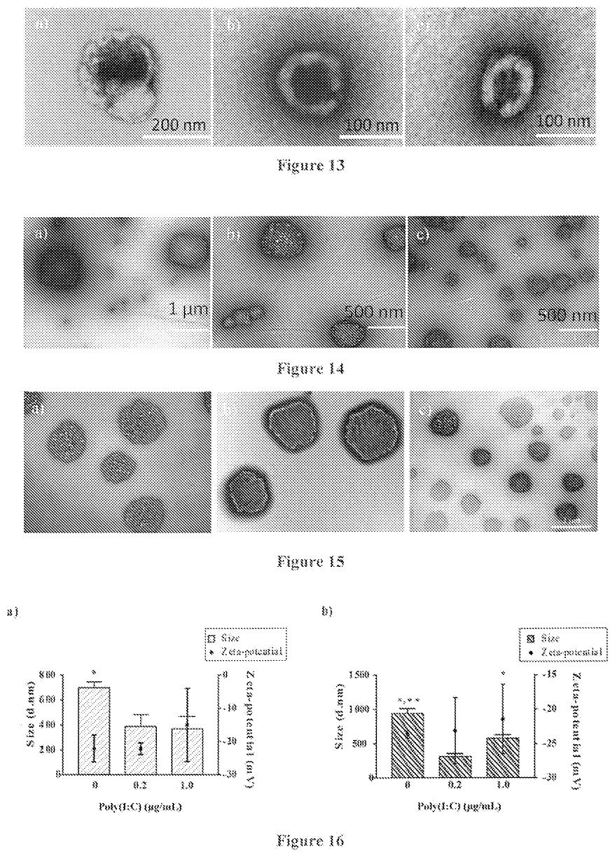

Transmission electron microscopy (TEM) images of the asiatic acid encapsulated nanoparticles are shown in the FIG. 14. The results showed that asiatic acid was successfully encapsulated into 0.1% w/v, 0.15% w/v and 0.25% w/v of Sample 2 in colloid form as determined by the changes in the size, shape, and appearance of the nanoparticles.

Transmission electron microscopy (TEM) images of the polyinosinic:polycytidylic acid (poly(I:C)) encapsulated nanoparticle are shown in the FIG. 15. The results showed that curcumin was successfully encapsulated into 0.1% w/v, 0.25% w/v and 0.5% w/v of Sample 2 in colloid form as determined by the changes in the size, shape, and appearance of the nanoparticles.

The encapsulation of polyinosinic:polycytidylic acid (poly(I:C)) is shown in FIG. 16. The results showed that different concentration (0.2 and 1 82 g/ml) of polyinosinic:polycytidylic acid (poly(I:C)) was encapsulated in Sample 2 in colloid form as determined by the particle size reduction of Sample 2 in 0.1% w/v (FIGS. 16a) and 0.5% w/v (FIG. 16b) compared with the active ingredient encapsulated sample.

### (8) Cellular Uptake

The cellular uptake test of curcumin-encapsulated Samples 1, 4 and 5 in colloid form was studied by the following procedures: NIH-3T3 cells were treated with Samples 1, 4 and 5 for 24 hours. After treatment, the cells were stained with 4′,6-Diamidino-2-phenylindole dihydrochloride (DAPI) (nuclear staining) and rhodamine-phalloidin (actin staining) for 15 to 30 minutes. Levels of cellular uptake were measured with fluorescence microscope after the 24-hour treatment.

Confocal microscopy images of curcumin cellular uptake efficiency test into NIH-3T3 cells are shown in FIG. 17. The results showed that cellular uptake of curcumin colloid was indicated by green fluorescence intensity and curcumin colloid was taken up by NIH-3T3 cells.

The cellular uptake test of Samples 3 encapsulated curcumin was studied by the following procedures: periodontal ligament stem cells were treated with Sample 3 for 24 hours. After treatment, the cells were stained with 4′,6-Diamidino-2-phenylindole dihydrochloride (DAPI) (nuclear staining) and rhodamine-phalloidin (actin staining) for 15 to 30 minutes. Levels of cellular uptake were measured with fluorescence microscope after the 24-hour treatment.

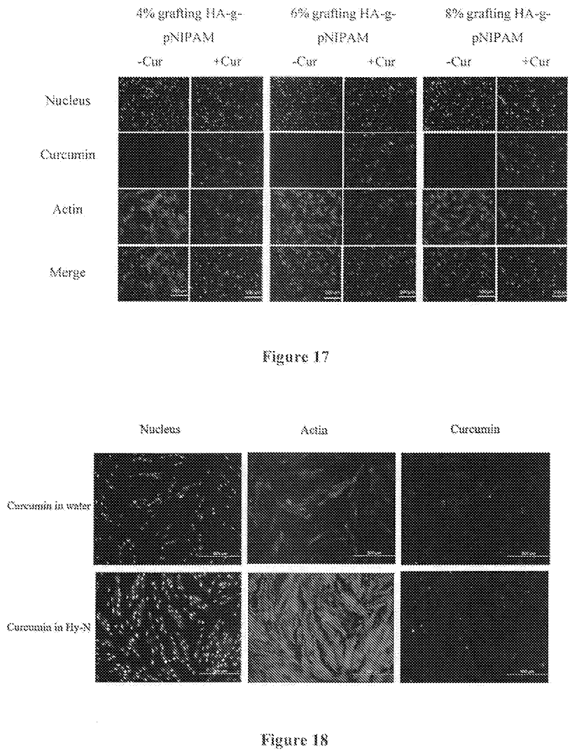

Confocal microscopy images of curcumin cellular uptake efficiency test into periodontal ligament stem cells are shown in FIG. 18. The results showed that cellular uptake of curcumin colloid indicated by green fluorescence intensity was higher than that of curcumin in water.

### (9) Permeability

The permeability of sodium ascorbyl phosphate (SAP) and SAP encapsulated with 0.1% w/v of Sample 2 in colloid form were tested in pigskin via Franz diffusion cell. The results showed that 6 μg/cm² of SAP and 68.78 μg/cm² of SAP encapsulated with 0.1% w/v of Sample 2 in colloid form were permeated into pigskin respectively. Thus, it was confirmed that HA-g-pNIPAM can enhance permeability into epidermis.

### (10) Stability of Active Pharmaceutical Ingredients

The fibroblast growth factor (FGF) stability including physical stability factors (i.e., color, precipitate), and chemical stability factors, (i.e. pH, cell proliferation induction in L-929 cell) of Sample 2 in colloid form was investigated by comparing FGF and FGF encapsulated in Sample 2. The experiments were conducted at 0, 2, 4, 8, and 18 weeks after incorporation of FGF into Sample 2 in colloid form.

Cell proliferation induction in L-929 cell is the metabolic rate analysis of L-929 cell with PrestoBlue™ assay. L-929 was incubated with Dulbecco's Modified Eagle Medium/Nutrient Mixture F-12 (DMEM-F-12) containing 5% v/v fetal bovine serum and 150 μL of 2 mM L-glutamine (“the media”) for 24 hours to enhance the attachment of the cell on 96-well plate. Then the media was removed and replaced by testing material: FGF (control), and FGF encapsulated in 50 μL of Sample 2 in each well. Moreover, the cell was incubated in an incubator at 5% CO₂, 37° C. for 24 hours. After that, the testing material was also removed, rinsed with phosphate buffer saline (PBS) with a pH of 7.4, replaced with 10% of

PrestoBlueTM containing media, and further incubated at 5% CO₂, 37° C. for an hour. Finally, fluorescence intensity was measured at 560/590 nm (excitation/emission) with a microplate reader.

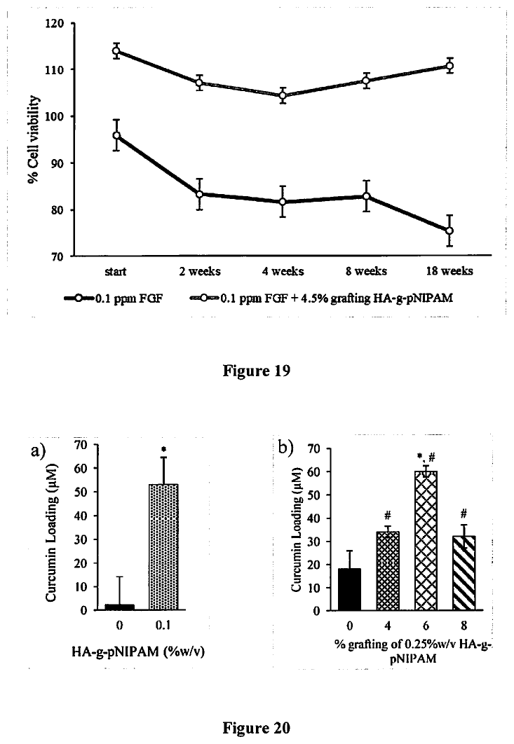

The cell viability test is shown in FIG. 19. The results showed that FGF-induced cell growth was maintained in the colloid-FGF formulation, while the biological activity of FGF dropped, over the 18-week period of storage.

### (11) Solubility

The solubility of Sample 2 in colloid form load with curcumin, asiatic acid, and resveratrol and Samples 1, 4 and 5 in colloid form load with curcumin were tested by the following procedure: ultraviolet-visible (UV-Vis) spectrophotometric analysis for resveratrol and curcumin, and high-performance liquid chromatographic analysis for asiatic acid.

The solubility of curcumin-loaded Sample 2 in colloid form at concentration of 0.1% w/v and Samples 1, 4 and 5 in colloid form at concentrations of 0.25% w/v are shown in FIG. 20. The result showed that, with Sample 2 at concentration of 0.1% (FIG. 20a), the colloid could increase solubility of curcumin by 26 times. Samples 1, 4, and 5 could increase solubility of curcumin around 2, 3, and 2 times, respectively, compared with the water as the control.

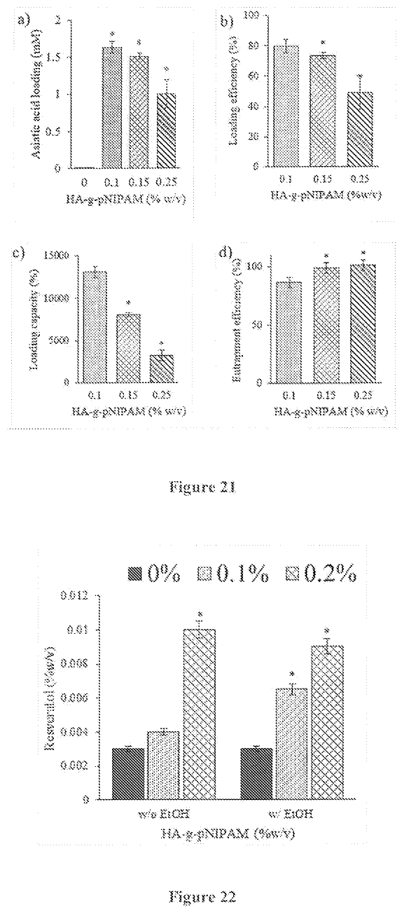

The solubility of asiatic acid-loaded Sample 2 in colloid form at concentrations of 0, 0.1, 0.15, and 0.25% w/v is shown in FIG. 21 in terms of loading amount (FIG. 21a), loading efficiency (FIG. 21b), loading capacity (FIG. 21c) and entrapment efficiency (FIG. 21d). The results showed that, with Sample 2 at concentrations of 0.1%, 0.15% and 0.25% in water, the colloid could increase asiatic acid loading of approximately 400, 370, and 250 fold, respectively, compared with the water as the control.

The solubility of resveratrol-loaded Sample 2 in colloid form at concentrations of 0, 0.1 and 0.2% w/v is shown in FIG. 22. The result showed that, with Sample 2 at concentration of 0.2% in water or in hydroalcoholic solution, the colloid could increase solubility of resveratrol by 4.5 to 5 times, compared with the water as the control.

### (12) Moisturizing Test

Moisturizing test of Sample 2 in colloid form at concentrations of 0.1 and 2% w/v was studied with 5 healthy volunteers by the following procedures: before the treatment, participants were required to abstain from cosmetics on the test area for a period of 1 week. The samples were applied evenly to the forearm twice a day for 14 days at a temperature of 25±2° C. and humidity of 50±5%. The skin's moisture content was checked before and after application of Sample 2 and its control using a measuring capacitor that was pressed against the skin using constant pressure and the readings evaluated by Corneometer. Alternatively, the Trans-epidermal water loss (TEWL) test was carried out using TEWL measurement probe comparing before and after application of Sample 2.

Moisturizing test of Sample 2 in colloid form at concentrations of 0.1 and 2% w/v is shown in Table 4. The result showed that Sample 2 could increase skin water content by 124% and 11.91% after applying with 2% and 0.1% concentration of Sample 2 in water, respectively, while the unmodified HA could not change the skin water content at 0.1% concentration of the control polymer. Moreover, trans-epidermal water loss (TEWL) could be reduced by 12.1% after the application of 0.1% of Sample 2 in water to the upper arm skin.

Table 4 shows the water content and trans-epidermal water loss (TEWL) of Sample 2

| | Water content | Water content | |
|---|---|---|---|
| | in epidermis | in epidermis | |
| | before applying | after applying | Change |
| | grafted polymer | grafted polymer | rate (%) |
| Hyaluronic acid | 37.2 | 36.1 | 2.96% |
| 0.1% w/v | 33.3 | 37.2 | 11.91% |
| HA-g-pNIPAM | | | |
| 2.0% w/v | 50 | 112 | 124% |
| HA-g-pNIPAM | | | |

| | Trans-epidermal | Trans-epidermal | |
|---|---|---|---|
| | water loss (TEWL) | water loss (TEWL) | |
| | before applying | after applying | Change |
| | grafted polymer | grafted polymer | rate (%) |
| 0.1% w/v | 12.4 | 10.9 | −12.1% |
| HA-g-pNIPAM | | | |

### (13) Toxicity of Hyaluronic Acid Grafted Poly(N-isopropylacrylamide) (HA-g-pNIPAM)

In vitro toxicity test of Sample 2 in colloid form in keratinocyte (HaCaT cell), fibroblast (BJ cell), and cornea epithelial cell was studied by the following procedures: Cells were treated with Sample 2 at concentrations of 0, 0.06, 0.12, 0.25, 0.5, 1 and 2% w/v for 24 hours, then the toxicity was evaluated with MTT assay.

Cytotoxicity test in keratinocyte (HaCaT cell) and fibroblast (BJ cell) is shown in the FIG. 7. These results showed Sample 2 did not reduce cell viability of both skin cells, suggesting that Sample 2 did not cause toxicity to both cell lines.

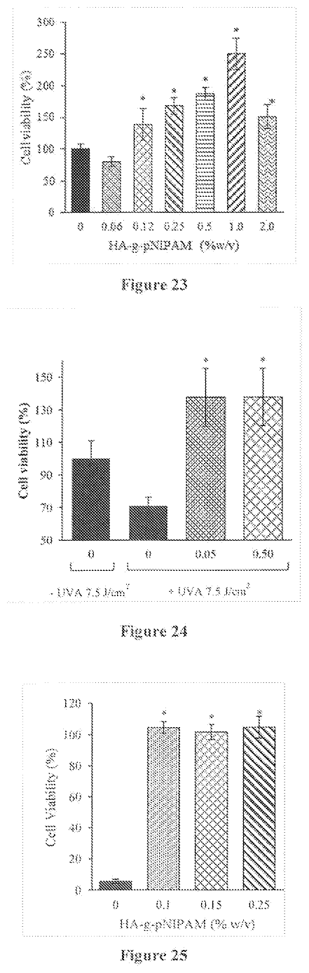

In addition, cytotoxicity test in cornea epithelial cell is shown in the FIG. 23. These results showed that no toxicity was observed in Sample 2 treated cells. These results support the safety profile of Sample 2.

### (14) Phototoxicity of HA-g-pNIPAM

In vitro phototoxicity test of Sample 2 in colloid form was studied by the following procedures: HaCaT keratinocytes were treated with Sample 2 at concentrations of 0, 0.05, and 0.5% w/v for 24 hours. After the treatment, cells were irradiated with 7.5 J/cm² of ultraviolet-A (UVA) and cell viability was then measured with MTT assay.

The phototoxicity test is shown in the FIG. 24. The result showed that Sample 2 can prevent toxicity caused by UVA irradiation.

### (15) Side Effect Test

Side effect test of Sample 2 in colloid form at concentration of 0, 0.1, 0.15 and 0.25% w/v form was studied by considering the toxic reduction of asiatic acid in fibroblast L929 cell via PrestoBlue™ assay.

The side effect test of Sample 2 in colloid form at concentrations of 0, 0.1, 0.15 and 0.25% w/v is shown in FIG. 25. The result showed that, when using 12.5 μM of asiatic acid dissolved in dimethyl sulfoxide (DMSO) in cell culture media, percentage of the cell viability reduced to 5%. However, cell viability increased to 100% when colloid was used to incorporate 12.5 μM asiatic acid with the tested concentrations of 0.1, 0.15 and 0.25% w/v of the sample to make colloid. Therefore, it was confirmed that hyaluronic acid grafted poly(N-isopropylacrylamide) (HA-g-pNIPAM) of the present invention can reduce the toxicity of asiatic acid.

### (16) Skin Irritation Test

Irritation test of Sample 2 in colloid form at concentration of 2.0% w/v was studied by 24-hour occlusive human patch test. After obtaining the informed consent and confirming the inclusion/exclusion criteria, i.e., all subjects must be healthy adults aged between 20 to 59 years and not have any exclusion criteria, the technician studied the back (paravertebral area) of each selected subject. Furthermore, the technician observed and photographed the test site on the upper back (paravertebral area) of each selected subject. Then the subjects were applied with test samples using patch test unit with an appropriate dosage. After 24 hours of the application, the patch was removed by the subjects themselves. Test area was photographed by the technician after 1 hour (total 24 hours) and 24 hours (total 48 hours) of the patch removal. Further judgments, e.g., skin reactive judgement, and determining skin irritation score, were assessed by a dermatologist.

The result showed that all 24 adult subjects did not have any reaction to the sample. As a result, the skin irritation score was calculated to be 0, which is less than 5 and, according to classification by Sugai (cosmetic sciences, 1995, 19:49-56.). Thus, this confirmed that Sample 2 is a safe and non-irritating product.

Table 5 shows skin reaction by 24-hour occlusive human patch test of Sample 2

| | | | White | | Sterile water | | Physiological | |
|---|---|---|---|---|---|---|---|---|
| | Sample 2 | | Petrolatum | | for Irrigation | | saline solution | |
| Skin Reaction | 24 h | 48 h | 24 h | 48 h | 24 h | 48 h | 24 h | 48 h |
| No reaction | 24 | 24 | 24 | 24 | 24 | 24 | 24 | 24 |
| Slight erythema | — | — | — | — | — | — | — | — |
| Definite erythema | — | — | — | — | — | — | — | — |
| Erythema + edema, | — | — | — | — | — | — | — | — |
| papule | | | | | | | | |

| | | | | |
|---|---|---|---|---|
| Skin Irritation Score | 0.0 | 0.0 | 0.0 | 0.0 |

### (17) Sensitization Test

Sensitization test of Sample 2 in colloid form at concentration of 2.0% w/v was studied by human repeated insult patch test (HRIPT) which is divided into four main phases including (1) screening phase, (2) induction phase, (3) rest period, and (4) challenge phase. In the screening phase, the informed consent and the inclusion criteria, i.e., all subjects must be healthy adults aged between 20 to 59 years and not have any exclusion criteria, was obtained and confirmed. Next, the technician observed and photographed the test site on the upper back (paravertebral area) of each selected subject. In the induction phase, the subjects were applied with test samples using patch test unit with an appropriate dosage. After 24 hours of the application, the patch was removed by the subjects themselves. Skin reactions were evaluated and photographed by a trained technician before application of the next patch test unit 24 hours or 48 hours later. The same samples were then applied by a technician on the same place on the back of each subject. This procedure was repeated 3 times per week for 3 consecutive weeks (a total of 9 sets of application and removal). After the induction phase, all subjects were given a rest period for 10 to 14 days. Finally, in the challenge phase, the same test samples were applied to the normal skin near the original application site during the induction phase using a patch test unit. Each patch test unit was removed from each subject 24 hours after its application. The test site of each subject was photographed by the technician and skin reactions were judged by a dermatologist at 1 hour and 24 hours after removal of the patch test unit (“After 24 h” and “After 48 h”, respectively).

The result of all 56 subjects showed that almost all subjects did not show any reaction, and just only 1-2 subjects showed slight erythema at the test site as shown in Table 6. This was interpreted that sample 2 was not cause of sensitization and can be considered a hypoallergenic product under the study condition.

Table 6 shows skin reaction by human repeated insult patch test (HRIPT) of Sample 2

| | | | | | | | | | | Challenge | |
|---|---|---|---|---|---|---|---|---|---|---|---|
| | Induction Phase | | | | | | | | | Phase | |
| Skin Reaction | 1^{st} | 2^{nd} | 3^{rd} | 4^{th} | 5^{th} | 6^{th} | 7^{th} | 8^{th} | 9^{th} | 24 h | 48 h |
| No reaction | 56 | 55 | 56 | 56 | 56 | 56 | 56 | 56 | 56 | 54 | 56 |
| Slight erythema | — | 1 | — | — | — | — | — | — | — | 2 | — |
| Definite erythema | — | — | — | — | — | — | — | — | — | — | — |
| Erythema + edema, | — | — | — | — | — | — | — | — | — | — | — |
| papule | | | | | | | | | | | |
| Total Subject | 56 | 56 | 56 | 56 | 56 | 56 | 56 | 56 | 56 | 56 | 56 |

### BEST MODE OF THE INVENTION

Best mode or preferred embodiment of the invention is as provided in the description of the invention.

1. A method for preparing hyaluronic acid grafted poly(N-isopropylacrylamide) (HA-g-pNIPAM) comprising the steps of:
a) preparing a mixture comprising hyaluronic compound, poly(N-isopropylacrylamide) and carbodiimide crosslinking agent in a water-miscible solvent;
b) reacting the mixture by adjusting pH to the range of 7.2 to 7.8 and stirring for 1 to 3 days at 20 to 40° C.; and
c) drying the mixture of step b),
wherein mole ratio of hyaluronic, poly(N-isopropylacrylamide), and carbodiimide crosslinking agent is in the range of 0.1:0.0025:1 to 0.2:0.0125:1.

2. The method according to claim 1, wherein the carbodiimide crosslinking agent is selected from 1-ethyl-3-(3-dimethylaminopropyl) carbodiimide (EDC), N-hydroxy succinimide (NHS), N,N′-dicyclohexylcarbodiimide (DCC), N,N′-diisopropylcarbodiimide (DIC) or a mixture thereof.

3. The method according to claim 2, wherein the carbodiimide crosslinking agent is a mixture of 1-ethyl-3-(3-dimethylaminopropyl) carbodiimide (EDC) and N-hydroxy succinimide (NHS) in a mole ratio of 1:0.5 to 1:1.5

4. The method according to claim 1, wherein a weight average molecular weight of hyaluronic compound is in the range of 30,000 to 60,000 Dalton.

5. The method according to claim 1, wherein the hyaluronic compound is selected from hyaluronic acid, hyaluronate salt, or a mixture thereof.

6. The method according to claim 5, wherein the hyaluronate salt is selected from sodium hyaluronate, potassium hyaluronate, or a mixture thereof.

7. The method according to claim 6, wherein the hyaluronate salt is sodium hyaluronate.

8. The method according to claim 1, wherein a weight average molecular weight of poly(N-isopropylacrylamide) is in the range of 4,000 to 6,000 Dalton.

9. The method according to claim 1, wherein the water-miscible solvent used in step a) is selected from water, phosphate buffer saline (PBS), citrate buffer, Tris buffer, potassium phosphate buffer, hydroalcoholic solution or a mixture thereof.

10. The method according to claim 9, wherein the water-miscible solvent used in step a) is water.

11. The method according to claim 1, wherein the method further comprises a step of adjusting pH of the mixture obtained from step a) to the range of 4.8 to 5.8 and stirring the mixture for 0.5 to 2 hours prior to conducting step b).

12. The method according to claim 1, wherein the pH is adjusted by a pH adjuster selected from sodium hydroxide, potassium hydroxide, sodium bicarbonate, or calcium hydroxide or a mixture thereof.

13. The method according to claim 11, wherein the pH is adjusted by a pH adjuster selected from hydrochloric acid, or sulfuric acid or a mixture thereof.

14. The method according to claim 1, wherein the step c) is conducted by a process selected from freeze-drying, vacuum drying, or air drying or the combination thereof.

15. The method according to claim 1, wherein the method further comprises a step of purifying the product obtained from step b) prior to conducting step c).

16. The method according to claim 15, wherein the step of purifying is conducted by dialysis, cross flow filtration, liquid-liquid extraction or the combination thereof prior to conducting step c).

17. A hyaluronic acid grafted poly(N-isopropylacrylamide) (HA-g-pNIPAM) obtained from the method according to any one of claims 1 to 16.

18. The hyaluronic acid grafted poly(N-isopropylacrylamide) according to claim 17, wherein said hyaluronic acid grafted poly(N-isopropylacrylamide) has a degree of grafting in the range of 4 to 8%.

19. A colloid of the hyaluronic acid grafted poly(N-isopropylacrylamide) according to any one of claims 17 to 19 in a water-miscible solvent selected from water, phosphate buffer saline (PBS), citrate buffer or a mixture thereof at a concentration of 0.0001 to 2% w/v
